(19) United States
(12) Patent Application Publication
(10) Pub. No.: US 2015/0073317 A1
(43) Pub. Date: Mar. 12, 2015

(54) DEVICE AND METHOD FOR APPLYING PRESSURE TO A MAMMALIAN LIMB

(71) Applicant: Wesley Cox, Fayetteville, AR (US)

(72) Inventor: Wesley Cox, Fayetteville, AR (US)

(21) Appl. No.: 14/022,998

(22) Filed: Sep. 10, 2013

(51) Int. Cl. A61H 1/00

(52) U.S. Cl. CPC A61H 1/008
USPC 601/84

(57) ABSTRACT

A therapeutic pressure band for applying pressure across a muscle or muscle groups on a mammalian limb is described. The band is particularly well suited for treating “shin splints.” The band includes a plurality of straps that are connected together via a connecting material. Ends of each of the straps have adjustable fasteners for securing and tightening the band around a limb. The band also possesses a plurality of pressure members (e.g., elongated rubber tubes) that apply separate and discrete areas or points of pressure in a line across a muscle, tendon, bone, or muscle group and generally perpendicular to a longitudinal axis of the limb.

### BACKGROUND OF THE INVENTION

The present invention relates generally to therapeutic devices. More specifically, the invention relates to a therapeutic pressure band for applying pressure to a mammalian limb. Particularly, the invention relates to a therapeutic pressure band for applying pressure across muscles near the insertion point of those muscles (i.e., near where the muscle inserts into the bone) and/or across the bone itself. Such devices are commonly used to provide pain relief for inflamed and painful muscles, tendons and joint capsules and are especially used for treating medial tibial stress syndrome, also known as “shin splints.”

The pathological condition generally known as shin splints afflicts many people. In many instances, shin splints (and other forms of tendonitis) is caused by overexertion and overloading of a muscle group during exercise, sports or simple repetitive motion. For example, if a person begins running extended distances after not running for a period of time, the tendons and muscles of the person's legs, especially the gastrocnemius, soleus, and plantar muscles, may be unable to absorb the impact of the shock force as they become fatigued. In particular, repetitive stress of the impact forces may eccentrically fatigue the soleus and create repeated tibial bending or bowing. In some instances, pressure across the tibia, and in some cases the fibula, will increase to a point where the bone will be painful as well.

Orthopedists observe that many patients having various forms of tendonitis and/or muscle inflammation, and particularly those having shin splints, experience pain relief when pressure is applied across the inflamed muscles, tendons, and bones. For those patients with shin splints placing a compressive band around the lower leg between the knee and ankle may provide some relief. Such bands are also utilized during use of the leg (e.g., jogging or repetitive movement at work) to dampen muscle movement and thereby reduce additional inflammation of the muscles and tendons.

However, the mammalian body is a very dynamic system. Treatments, braces, and straps that provide relief for one patient often do not provide relief for another, which is one reason there is such a large number of orthopedic devices on the market for all types of orthopedic conditions. Accordingly, there is a continuing need for new and innovative orthopedic devices to provide treatment and relief to those patients that do not respond to known treatment methods.

### SUMMARY OF THE INVENTION

In one aspect, the invention is a therapeutic pressure band for applying pressure to a limb. The pressure band comprises a plurality of flexible straps for encircling a limb and a connecting material extending between each adjacent strap to secure the straps together. The straps each have adjustable cooperative fasteners proximate their ends for adjustably fastening the straps about the limb. A plurality of elongated pressure members are attached to the band and positioned between the adjustable cooperative fasteners. Each flexible strap includes one elongated pressure member attached thereto, and the pressure members are separated from each other by a distance and oriented substantially perpendicular to a longitudinal axis of the limb. During use, each pressure member creates a discrete line of pressure across the limb.

In another aspect, the invention is a method of simultaneously applying a plurality of discrete lines of pressure to a limb. The method comprises the steps of encircling the limb with a pressure band, with the band having a plurality of flexible straps and with each of the straps having adjustable cooperative fasteners proximate ends of the straps for adjustably fastening the straps about the limb. The band also has a plurality of elongated pressure members, with each of the straps having one pressure member attached thereto. The pressure members are separated from each other by a distance and oriented substantially perpendicular to a longitudinal axis of the limb when the band is in use. The method also includes the step of adjusting the cooperative fasteners of each of the straps to tighten the band around the limb thereby compressing each pressure member against the limb to create discrete lines of pressure across the limb.

A still further aspect of the invention is a method of applying a plurality of independent lines of pressure to a limb. The method comprises the steps of placing a plurality of elongated pressure members against the limb, with each of the pressure members including a force transfer surface, and wherein each of the elongated pressure members are operable to apply a line of pressure that is independent of lines of pressure being applied by other pressure members. The steps additionally include creating a plurality of circumferential compressive forces around the limb. The steps further include concentrating a portion of each of the plurality of the compressive forces at the force transfer surface of each of the pressure members.

### BRIEF DESCRIPTION OF THE DRAWINGS

These and other more detailed and specific features of the present invention are more fully disclosed in the following specification, reference being had to the accompanying drawings, in which:

FIG. 1A is a perspective view of an embodiment of the invention.

FIG. 1B is a perspective view of an alternative embodiment of the invention.

FIG. 2 is a top plan view of the embodiment of FIG. 1B.

FIG. 3 is a view taken on lines 3-3 of FIG. 1A.

FIG. 4 is a view taken on lines 4-4 of FIG. 1B.

### DETAILED DESCRIPTION OF THE INVENTION

In the following description, for purposes of explanation, numerous details are set forth, such as device configurations and movements, to provide an understanding of one or more embodiments of the present invention. Furthermore, the following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

While the invention is described with respect to various embodiments thereof, it will be understood by those skilled in the art that various changes in detail may be made therein without departing from the spirit, scope, and teaching of the invention. Accordingly, the invention herein disclosed is limited only as specified in the claims.

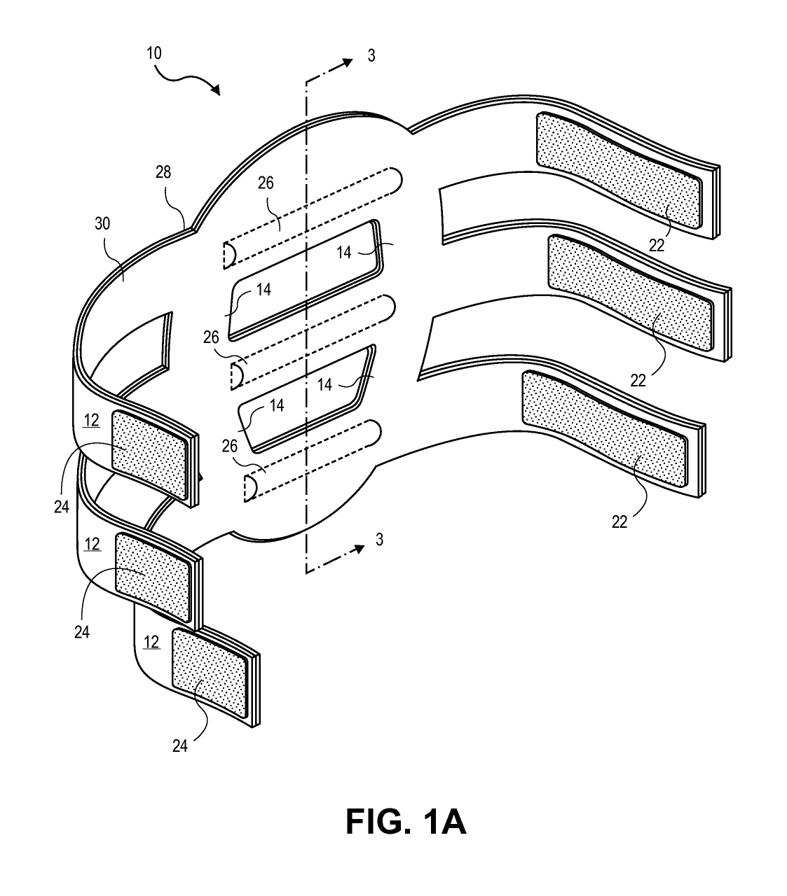

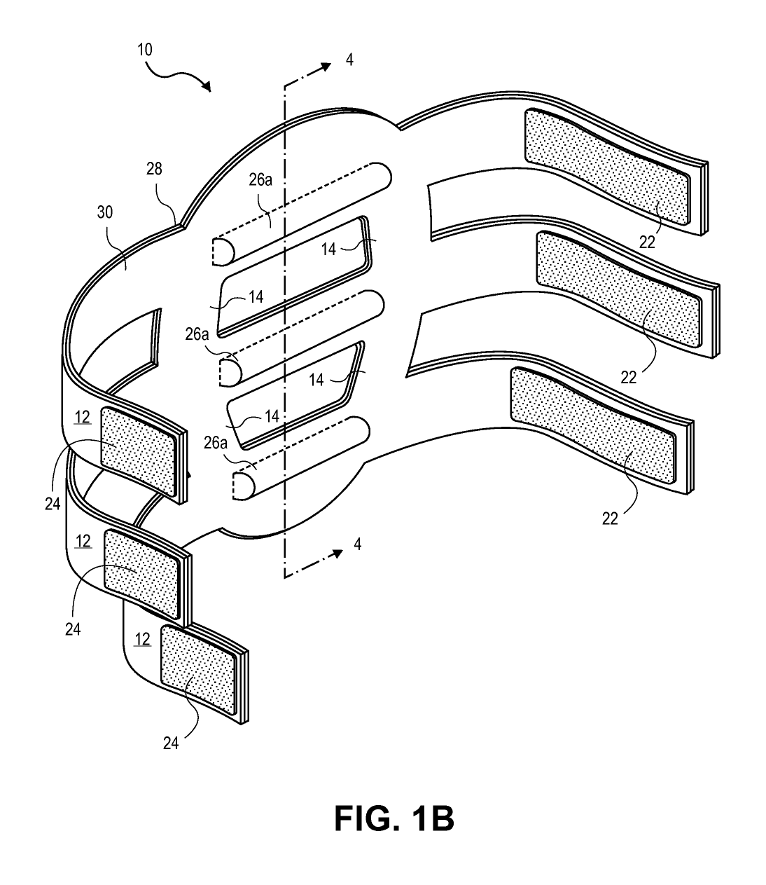

Referring now to the drawings in detail, where like numerals refer to like parts or elements, there is shown in FIGS. 1A and 1B a therapeutic pressure band generally designated by the numeral 10. The pressure band 10 is designed to apply pressure to the muscles and/or bones of a limb (not shown). For ease of discussion the detailed description describes an embodiment of the invention in the context of a band used in the treatment of shin splints in a human. This narrative convenience should not be interpreted as limiting the scope of the invention. The band 10 of the present invention includes means for applying a plurality of discrete lines of pressure to the muscles, tendons, and/or bones of a limb. Those skilled in the art recognize that depending upon the placement of the band, the lines of pressure provided by the band will be above muscle, tendon, bone, the transition area between the muscle and the tendon, and/or the transition areas between the muscle, tendon, and bone. Therefore, as used herein and for clarity, the term muscle or muscles includes the primarily fibrous portions of a muscle, commonly known as tendons, which attach the muscle to bone as well as the contractive tissue commonly referred to as muscle.

In more detail, the pressure band 10 according to embodiment of the present invention broadly comprises a plurality of elongated flexible straps 12 of sufficient length such that the pressure band is capable of encircling the limb to be treated. The pressure band 10 includes connection material 14 that extends between and connects the straps 12 together. In certain embodiments, the pressure band 10 also includes a plurality of adjustable cooperative fasteners proximate ends of the each of the plurality of straps 12 for adjustably fastening and/or securing the straps and thus the pressure band about the limb, for creating a compressive force or pressure about the limb, and for adjusting the force/pressure applied to the limb. Each of the pressure straps 12 contains a pocket 26, 26a that is integral with the strap. In certain embodiments, the pockets 26, 26A located on adjacent straps 12 are separated from each other by a distance 32. In certain embodiments, an elongated pressure member 34, 34a is contained within each of the pockets 26, 26A. During use of the pressure band 10 in certain embodiments, the pressure members 34, 34a are oriented substantially perpendicular to a longitudinal axis of the limb and each pressure member creates a distinct line of pressure across the muscles and/or bone of the limb. Each element is discussed in more detail below.

Of note, some embodiments of the present invention include features similarly found in certain portions of the inventive concepts disclosed in co-pending application U.S. Ser. No. 13/731,289 filed on Dec. 31, 2012, and entitled “A DEVICE AND METHOD FOR APPLYING PRESSURE TO A MAMMALIAN LIMB,” the entire disclosure of which is herein incorporated by reference into the present application.

In certain embodiments, the pressure band 10, including portions the flexible straps 12 and the connecting material 14, are constructed of a suitable flexible material such as woven fabric, vinyl, leather, neoprene, nylon, etc. In some embodiments, the material utilized to construct the band 10 has some elastic qualities, or in other embodiments, the material is mostly inelastic. If elastic materials are utilized, then care should be taken when the band 10 is applied to a limb because elastic materials make it easier to inadvertently cut off blood circulation to a limb. In certain embodiments, the pressure band 10 is mostly made of a single material for ease of manufacture or, in alternative embodiments; it is made from a combination of materials where the materials are chosen for specific purposes. For example in some embodiments, one portion of the band 10 is formed from relatively inelastic leather while another portion is formed from somewhat elastic neoprene. In certain embodiments, a portion or multiple portions of the band 10 are formed of solid materials (e.g., thin polymer sheets) to add strength to the strap or focus pressure in a particular area.

The architecture of the plurality of straps 12 can vary considerably. In certain embodiments, the straps 12 are formed of a single layer of material, or in alternative embodiments, the straps 12 are made of multiple layers of material. If a single layer of material is used, slight adjustments in the manner of attaching the pressure members 34, 34a (discussed below) to the straps 12 are necessary. Such adjustments are well within the knowledge of those skilled in the art.

In preferred embodiments the straps 12 are formed of multiple layers as shown in FIGS. 1A and 1B. The band 12 shown in the figures comprises a first layer 28 attached to a second layer 30. In other embodiments, additional layers can be utilized if desired. For example, in some embodiments, a layer of foam is added to provide comfort for the user.

The therapeutic pressure band 10 includes adjustable cooperative fasteners proximate the ends of each of the straps 12 for adjustably fastening the band about the limb to create compressive forces or pressures about the limb and for adjusting the forces/pressures applied to the limb. In certain embodiments, such as illustrated in the drawings, a Velcro type fastener is utilized on the ends of the straps 12, including a strip of hook portion 22 on a first end and a strip of fiber loop portion 24 on a second end. In other embodiments, a single, large piece of Velcro (either a hook portion or a loop portion) extends between and connects together each of the straps 12 on their first end. As such, the second ends of each of the straps 12, which also include Velcro, are capable being fastened to the large piece of Velcro. Although Velcro type fasteners are preferred due to ease of use, in other embodiments, other types of fasteners such as buckles, snaps, latches, or the like can be used in the practice of the invention. For example, in certain embodiments, a metal or polymeric loop is attached to a first end of a strap 12 via a small tube extending across the first end of the strap, and a second end of the strap is capable of being inserted through loop and secured in place with Velcro, prongs, clasps, or the like.

As illustrated by FIGS. 1A and 1B, the straps 12 of the band 10 are secured together and interconnected by the connecting material 14. In certain embedment's, such as those shown in the drawings, the connecting material 14 extends between the straps 12, such that the connecting material presents an egg-shaped or oval-shaped form. The egg-shaped or oval-shaped form may be preferred in embodiments in which the band 10 is secured to a user's lower log leg, such as for instance to treat shin splints. As such, the egg-shaped form or oval-shaped form corresponds to a shape of the user's lower leg to facilitate proper placement and fit. In other embodiments, the connecting material 14 extends between the straps 12, such that the connecting material presents other-shaped forms, such as circular, triangular, rectangular, or the like.

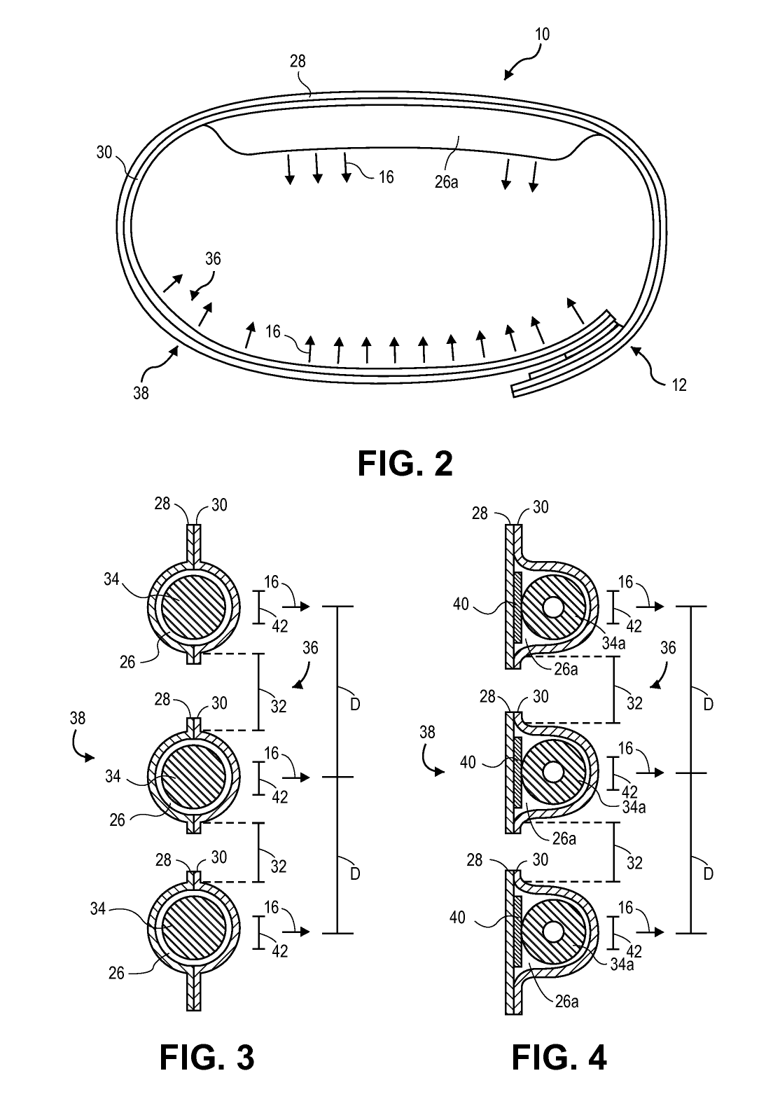

FIG. 2 illustrates the engagement of the fasteners of the band 10 and how such an engagement creates compressive forces/pressures around a limb. As the ends of the straps 12 are secured together, the circumference of the band 10 contracts causing compressive forces around the interior of the band. These forces are illustrated by the force vector arrows 16 shown in FIGS. 2, 3 and 4 and are discussed in more detail below.

In one embodiment of the band 10 according to the invention the means for applying a plurality of discrete lines of pressure to a limb comprise the plurality of pockets 26, 26a that are integral to each of the straps 12. In certain embodiments, the pockets 26, 26a are formed within the straps 12, or in alternative embodiments, are formed separately and attached to the straps 12.

In certain embodiments, the manner in which the pockets 26, 26a are formed vary with the methods used to manufacture the band 10. For example, in the embodiment of the invention shown in FIGS. 1A and 3, the band 10 is formed of multiple layers of material. In this embodiment the band 10, and more specifically the straps 12, is formed of a first layer 28 of material attached to a second layer 30 of material. The method of attaching the first layer 28 to the second layer 30 includes any method known in the art such as sewing or gluing. Those skilled in the art can pick the method of attachment that is most suitable for the materials used to construct the band 10.

In the embodiment shown in FIG. 3 the first 28 and second 30 layers are joined by sewing the layers together. The pockets 26 are located intermediate the first and second layer 28, 30 in the potential space that exists between the layers. In the embodiment shown in FIG. 3 there exist three pockets 26 formed between the layers 28, 30 and extending longitudinally along each of the straps 12. In certain embodiments, the pockets 26 are completely enclosed, or in other embodiments, they have small openings (not shown) at one end. Providing small openings allows the user to change out the pressure members (described in more detail below) that reside therein (e.g., remove a more rigid member for a more compliant member).

Turning now to FIG. 4, in an alternative embodiment, the band 10, and more specifically the straps 12, is constructed such that the pockets 26a are primarily arranged to be on one side of the straps 12. In both embodiments and particularly the embodiment shown in FIGS. 3 and 4, the band 10 can be described as having an inside surface 36 and an outside surface 38 where the inside surface 36 faces the limb as shown in FIG. 2. In the embodiments shown in FIG. 4, the pockets 26a are positioned primarily on the inside surface 36 of the band 10. In some embodiments, the pockets 26a have small openings (not shown) that allow a user to change out pressure members.

The pockets 26a shown in FIG. 4 are similar to the pockets shown in FIG. 3 in that they are positioned intermediate a first 28 and second 30 layer. They are different in that the portion of the straps 12 that is between pressure members 34a and the outside surface 38 is reinforced to be more rigid and less capable of deforming to conform to the shape of the pressure member 34a as shown in FIG. 4.

In embodiments of the present invention, the reinforcement of the straps 12 to form the style of pockets 26a shown in FIG. 4 takes several forms. One option is to place a backing plate 40 intermediate the pressure members 34a and the outside surface 38. In certain embodiments, the backing plate 40 is semi-flexible (for example, a thin piece of plastic). In other embodiments, the backing plate 40 is formed from a rigid material that has a curvature to conform to the natural curvature of the limb. Another alternative embodiment for reinforcing the straps 12 is to use multiple layers of material (e.g., fabric, leather) to create the “outer” portion the straps. Either method of reinforcement, results in pockets 26a that generally protrude toward the inside of the band 10.

The pressure members 34, 34a used in the practice of the invention are sized to fit within the pockets 26, 26a. The pressure members are elongated to provide continuous lines of pressure that extend for a distance across a muscle, muscle group, and/or bone of a limb. Those skilled in the art recognize that the pressure (and force vectors) applied by the pressure members 34, 34a to a limb extends along lines that are generally perpendicular to the longitudinal axis of the limb.

Pressure members having a circular or hemispherical cross-section are preferred because they create a generally smooth and uniform force transfer surface (generally represented by numeral 42) when compressed against a limb. In other embodiments, other cross sections (for example, hexagonal or star shaped) are used in the practice of the invention and may provide more relief for some patients. In addition, embodiments provide for the pressure members 34, 34a to be either solid or hollow as shown in FIGS. 3 and 4 respectively. Similarly, embodiments provide for the material used to construct the pressure members to vary depending upon the amount of pressure desired. For example, a hollow tube of very flexible and soft rubber would have a pressure distribution profile that is different from a solid tube of fairly rigid nylon. One patient may prefer one type of pressure member over another.

In certain embodiments, each of the pressure members 34, 34a on the straps 12 will have similar lengths. For instance, in some specific embodiments, each of the pressure members 34, 34a will have a length within a range from about 2 inches to about 4 inches. In certain specific embodiments, each of the pressure members 34, 34a will have lengths that are about 2.25 inches, 2.75 inches, or 3.00 inches. In certain other embodiments, one or more of the pressure members 34, 34 of the straps 12 will have different lengths. For instance, in certain embodiments in which the band 10 is positioned on a user's lower leg, the pressure members 34, 34a that are positioned higher will be longer than the pressure members 34, 34a that are positioned lower. With reference to FIGS. 1A and 1B, for example, the pressure members 34, 34a positioned near an upper portion of the band 10 are longer than the pressure members 34, 34a positioned near a lower portion of the band. Such embodiments may be beneficial for use on a user's leg because a width of the user's leg generally decreases moving from an upper portion of leg to a lower portion leg. In certain embodiments in which the pressure members 34, 34a are of different lengths, a first pressure member that is positioned directly below a second pressure member will have a length that is about 95 percent, 90 percent, 85 percent, 80 percent, 75 percent, or less than the length of the second pressure member. In certain specific embodiments of the band 10, such as illustrated in the drawings and that include three straps 12 and 3 pressure members 34, 34a, the band will include an upper pressure member that is about 3.00 inches long, a middle pressure member that is about 2.75 inches long, and a bottom pressure member that is about 2.25 inches long.

In all embodiments of the band 10, the pockets 26, 26a are separated from each other by a distance 32. The length of the distance 32 is that which is sufficient to create a plurality of separate and discrete lines of pressure across the band 10. Stated alternatively, the pressure members do not touch or adjoin or abut to create a single, concentrated, uniform area of pressure when the band is applied to a limb. Stated in yet a further alternative, the lines of force vectors 16 created by the pressure members 34, 34a and which are directed toward the limb are separated by a distance “D” that is greater than the sum of the radii of any two adjacent pressure members 34, 34a. Stated more simply, there is a gap between adjacent pressure members 34, 34a.

Embodiments of the present invention provide for the distance between the pockets and pressure members to vary depending upon the size of the pressure members, the width of the straps, the pocket material thickness, and the size of the limb. For those bands used in the treatment of shin splints, embodiments provide for the distance 32 to range between about ¾ inch to about 2 inches or greater. In other embodiments, the distance 32 ranges between about ¼ inch to about ¾ inch. In still other embodiments, the distance 32 ranges from about 2 inches to about 4 inches. Furthermore, it is envisioned that a certain distance 32 that provides relief for some patients will not provide relief for other patients. Thus, it is expected that bands 10 that include various sizes and distances 32 will be manufactured in accordance with the practice of the invention.

As described, embodiments of the present invention allow for the pressure members 34, 34a to apply discrete lines of pressure to muscle, tendon, and/or bone of a limb. In particular, the lengths of the pressure members 34, 34a (as described above) and the separation distance between the pressure members (as described above), allow for the discrete lines of pressure to be applied to the limb in a plurality of arrangements. For example, in some embodiments, all of the band's 10 pressure members 34, 34a will be applied only to the muscles or muscle group of the limb, only to the tendon of the limb, or only to the bone of the limb. In other embodiments, one or more of the pressure members 34, 34a will be applied to the muscles or muscle group of the limb, while one or more other of the pressure members will simultaneously be applied to the tendons that connect the muscle or muscle group to the bone of the limb. In still further embodiments, one or more of the pressure members 34, 34a will be applied to the muscles, muscle group, and/or tendon of the limb, while one or more other of the pressure members will simultaneously be applied to the bone of the limb. Such varying arrangements for the application of the pressure members 34, 34a are due, in part, to the placement, length, and separation of each of the pressure members of the band 10 according to embodiments of the present invention.

Another aspect of the invention is a method of simultaneously applying a plurality of discrete lines of pressure to the muscles and/or bone of a limb such as a human leg. The method comprises the step of encircling a limb with an elongated band such as the band 10 with the plurality of straps 12 discussed above. In particular, the band utilized in the method has adjustable cooperative fasteners proximate the ends of the straps for adjustably fastening the band about the limb. The band also possesses a plurality of elongated pressure members, such as those described previously, where the pressure members are separated by a distance and oriented substantially perpendicular to the longitudinal axis of the limb when the band is in use. The pressure members are preferably retained within discrete pockets that are integral to the straps of the band as discussed previously.

The method continues by adjusting the cooperative fasteners for each of the straps to tighten the band around the limb thereby compressing each pressure member against the limb to create discrete lines of pressure across the muscles and/or bone of the limb where the lines of pressure are separated by a distance. Because each of the straps includes its own pressure member, embodiments of the present invention provide for a user to independently adjust a magnitude of the pressure applied via each the pressure members. As such, the band of the present invention is capable of applying varying magnitudes of pressure for each of its straps and pressure members, such that a user can customize the applied lines of pressure as may be required for the user's individual needs. For example, if a user applies the band 10 of embodiments of the present invention to the user's shin to treat shin splints, the user can individually adjust the amount of pressure applied to the user's leg via each pressure member 34, 34a. In more detail, if an upper portion of the user's shin is more inflamed than a lower portion, the user can apply greater pressure to the upper portion than the lower portion. Specifically, the user can adjust the cooperative fasteners of the straps 12 so that upper straps are fastened tighter than lower straps. As such, the pressure members 34, 34a associated with the upper straps will impart greater pressures, than the pressure members associated with the lower straps.

In yet another aspect, the invention is a method of simultaneously applying a plurality of discrete lines of pressure to the muscles and/or bone of a limb. The method comprises the step of placing a plurality of discrete elongated pressure members against a limb where the elongated pressure members are the same as those discussed in relation to the pressure band 10 according to the invention. When the band is in use the elongated pressure members are substantially perpendicular to the longitudinal axis of the limb and are separated from each other by a distance. The pressure members also have a force transfer surface that extends for a distance across the surface of the limb.

The method continues with the step of creating a circumferential compressive force around the limb. This step is typically accomplished by tightening the band 10 around the limb to create compressive forces similar to those illustrated in FIG. 2. Tightening the straps 12 of the band 10 forces the pressure members, more specifically the force transfer surfaces 42 of the pressure members 34, 34a into the limb, which concentrates a portion of the compressive force applied to the limb at the force transfer surface 42. This in turn creates the continuous lines of pressure that aid in dampening movement of the muscles, tendons, and/or bone.

In the drawings and specification, there have been disclosed typical embodiments on the invention and, although specific terms have been employed, they have been used in a generic and descriptive sense only and not for purposes of limitation, the scope of the invention being set forth in the following claims.

I claim:

1. A therapeutic pressure band for applying pressure to a limb, said pressure band comprising:
a plurality of flexible straps for encircling the limb;
a connecting material extending between each adjacent strap to secure said straps together;
adjustable cooperative fasteners proximate ends of said straps for adjustably fastening said straps about the limb; and
a plurality of elongated pressure members attached to said band and positioned between said adjustable cooperative fasteners,
wherein each flexible strap includes one elongated pressure member attached thereto, and wherein adjacent pressure members are separated by a distance and adapted to be oriented substantially perpendicular to a longitudinal axis of the limb during use whereby each pressure member is operable to create a discrete line of pressure across the limb.

2. The pressure band of claim 1 wherein each of said straps includes a pocket and wherein each pocket retains one of said pressure members.

3. The pressure band according to claim 2 wherein the portion of each of said strap having said pocket comprises a first layer attached to a second layer with said pocket formed between the first and second layer.

4. The pressure band according to claim 2 wherein said band has an inside surface and an outside surface where the inside surface faces the limb and wherein said pockets are located on the inside surface of said band.

5. The pressure band according to claim 1 wherein the connection material extends between the plurality of straps such that the connection material presents an egg-shaped form.

6. The pressure band according to claim 1 wherein the lines of the force applied by each of said pressure members are separated by a distance that is between about ¾ inch to about 2 inches.

7. The pressure band according to claim 1 wherein said elongated pressure members are solid in cross-section.

8. The pressure band according to claim 1 wherein said elongated pressure members are hollow in cross-section.

9. The pressure band according to claim 1 wherein each of said pressure members has a length, and the lengths of all of said pressure members are equal.

10. The pressure band according to claim 1 wherein each of said pressure members has a length, and the lengths of all of said pressure members are not equal.

11. The pressure band according to claim 10 wherein a first length of a first pressure member positioned below a second pressure member is less than a second length of the second pressure member, and wherein the first length is between about 80 percent to about 95 percent of the second length.

12. A method of simultaneously applying a plurality of discrete lines of pressure to a limb, the method comprising the steps of:
encircling the limb with a pressure band, said band having a plurality of flexible straps, with each of said straps having adjustable cooperative fasteners proximate ends of said straps for adjustably fastening said straps about the limb, said band further having a plurality of elongated pressure members, with each of said straps having one pressure member attached thereto and with said pressure members being separated by a distance and oriented substantially perpendicular to a longitudinal axis of the limb during use; and
adjusting the cooperative fasteners of each of said straps to tighten said band around the limb thereby compressing each pressure member against the limb to create discrete lines of pressure across the limb.

13. The method according to claim 12 wherein each of said straps includes a pocket and wherein each pocket retains one of said pressure members.

14. The method according to claim 12 wherein in the adjusting step, each of said straps is capable of being independently fastened about the limb such that the discrete lines of pressure each comprise different pressure magnitudes.

15. The method according to claim 12 wherein each of said pressure members has a length, and the lengths of all of said pressure members are equal.

16. The method according to claim 12 wherein each of said pressure members has a length, and the lengths of all of said pressure members are not equal.

17. The method according to claim 16 wherein a first length of a first pressure member positioned below a second pressure member is less than a second length of the second pressure member, and wherein the first length is between about 80 percent to about 95 percent of the second length.

18. A method of simultaneously applying a plurality of independent lines of pressure to a limb, the method comprising the steps of:
placing a plurality of elongated pressure members against the limb, with each of said pressure members comprising a force transfer surface,
wherein each of said elongated pressure members is operable to apply a line of pressure that is independent of lines of pressure being applied by other pressure members in the plurality of pressure members;
creating a plurality of circumferential compressive forces around the limb; and
concentrating a portion of each of the plurality of the compressive forces at the force transfer surface of each of said pressure members.

19. The method according to claim 18 wherein the step of creating a plurality of circumferential compressive force around the limb comprises tightening a plurality of straps of a band around the limb.

20. The method according to claim 19 wherein the pressure members are placed above muscles of the limb.
